(19) United States
(12) Patent Application Publication
(10) Pub. No.: US 2008/0202940 A1
(43) Pub. Date: Aug. 28, 2008

(54) Electrodes With Increased Surface Area And Methods of Making

(76) Inventors: Xiangchun Jiang, St. Paul, MN (US); Ronald W. Heil, Roseville, MN (US); Daniel J. Cooke, Roseville, MN (US)

Correspondence Address: PAULY, DEVRIES SMITH & DEFFNER, L.L.C., PLAZA VII- SUITE 3000, 45 SOUTH SEVENTH STREET, MINNEAPOLIS, MN, 55402-1630, US

(21) Appl. No.: 11/677,905

(22) Filed: Feb. 22, 2007

(51) Int. Cl. B23H 3/06

(52) U.S. Cl. 205/640

(57) ABSTRACT

Disclosed herein, among other things, are high surface area electrodes and methods of making the same. In an embodiment, the invention includes a method of increasing the surface area of an electrode of an implantable medical device including immersing the electrode in an electrolyte solution and oxidatively removing material from the surface of the electrode. In an embodiment, the invention includes a method of increasing the surface area of an electrode of an implantable medical device including immersing the electrode in an electrolyte solution and applying an oscillating electrical potential. In an embodiment, the invention includes a method of manufacturing an implantable stimulation lead including welding an electrode to a conductor and increasing the surface area of the electrode by oxidatively removing a portion of the electrode surface. Other aspects and embodiments are provided herein.

### TECHNICAL FIELD

This disclosure relates generally to electrodes and, more particularly, to electrodes with increased surface area and related methods.

### BACKGROUND OF THE INVENTION

Electrical pulses delivered by cardiac pacing systems excite cardiac tissue by the creation of an electrical field at the interface of a stimulating electrode and the underlying myocardium. For a pacing pulse to induce a response in excitable tissue, the pulse must be of sufficient amplitude and duration to initiate a self-regenerating wavefront of action potentials that propagate away from the site of stimulation and through a cardiac chamber (“cardiac capture”) causing the chamber to contract. The magnitude and duration of the pulse needed to achieve cardiac capture is referred to as the stimulation threshold. The stimulation threshold is a function of the current density generated at the electrode used to deliver the pulse.

In general, the smaller the radius of the electrode, the greater the current density. In addition, the resistance at the electrode-myocardial interface is higher with smaller electrodes, providing for the efficient use of a constant-voltage pulse and improving battery longevity. For these reasons, electrodes with a small radius are generally favored for myocardial stimulation.

After a pacing pulse is delivered, an afterpotential of opposite charge is induced in the myocardium at the interface of the stimulating electrode. For example, immediately after cathodal stimulation, an excess of positive charges surrounds the electrode, which then exponentially decays to electrical neutrality. This positively charged after potential can be inappropriately sensed by the sensing circuit of the pulse generator with resulting inhibition of the next pacing pulse. However, electrode polarization is known to decrease with electrodes of larger surface area. Therefore, because larger electrodes generally have larger surface areas, the issue of electrode polarization favors the use of a relatively large electrode to minimize after potentials.

One solution to these apparently conflicting design considerations regarding electrode size has been to develop electrodes that have a relatively small radius but include complex surface features that effectively provide a large surface area.

However, existing methods for increasing electrode surface area can be time-consuming, costly, or require the use of hazardous chemicals. In addition, some current methods for increasing the surface area of electrodes results in surface features that are not durable and therefore effectively lose surface area with use. For at least these reasons, there remains a need for high surface area electrodes and methods of making the same.

### SUMMARY OF THE INVENTION

This disclosure relates generally to electrodes with increased surface area and related methods. In an embodiment, the invention includes a method of increasing the surface area of an electrode of an implantable medical device, the method including immersing the electrode in an electrolyte solution, the electrode having a surface comprising platinum, and oxidatively removing material from the surface of the electrode.

In an embodiment, the invention includes a method of increasing the surface area of an electrode of an implantable medical device including immersing the electrode in an electrolyte solution, the electrode comprising platinum; and applying an oscillating electrical potential with a peak of equal to or less than about 4.0 Volts (SCE) to the electrode at a frequency of about 0.1 Hz to about 120 Hz to increase the surface area of the electrode.

In an embodiment, the invention includes a method of manufacturing an implantable stimulation lead including welding an electrode to a conductor and increasing the surface area of the electrode by oxidatively removing a portion of the electrode surface.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

The invention may be more completely understood in connection with the following drawings, in which:

FIG. 1 is a schematic diagram of a stimulation lead in accordance with an embodiment of the invention.

FIG. 2 is a schematic diagram of an apparatus for increasing surface area in accordance with an embodiment of the invention.

FIG. 3 is a flow chart showing processes in accordance with some embodiments of the invention.

FIG. 4 is a graph showing a square wave oscillating electrical potential in accordance with an embodiment of the invention.

FIG. 5 is a graph showing a sinusoidal wave oscillating electrical potential in accordance with an embodiment of the invention.

FIG. 6 is a graph showing current versus applied potential as measured in accordance with cyclic voltammetry analysis.

FIG. 7 is a flow chart showing processes associated with manufacturing leads in accordance with an embodiment of the invention.

FIG. 8 is a graph showing dissolved platinum versus surface area on modified electrodes.

FIG. 9 is a graph showing reduction charge versus electrolyte solution pH for electrodes modified as described herein.

While the invention is susceptible to various modifications and alternative forms, specifics thereof have been shown by way of example and drawings and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION OF THE INVENTION

As described above, it can be desirable to increase the surface area of an electrode on a stimulation lead. One way to increase the surface area, while not affecting the overall size is to create surface features on the electrode, effectively making the surface more rough. This approach can allow for relatively high current density around the electrode while minimizing the effects of electrode polarization. In addition to these electrical benefits, roughening the surface of electrodes can also offer other advantages, such as aiding in attaching other components to the electrodes. In addition, while not intending to be bound by theory, it is believed that roughening the surface of electrodes can facilitate the in-growth of tissue to the electrodes which can be advantageous under some circumstances, such as by aiding in the fixation of electrodes to target tissues.

Embodiments of the invention can include methods for increasing the surface area of an electrode. In some embodiments, the invention includes removing an amount of the surface material from an electrode leaving behind a roughened surface having increased real surface area. In the context of leads that are implanted within a patient, the approach of removing material to increase surface area can offer various advantages. By way of example, increasing surface area by removing material from electrode surface, in contrast to depositing material onto the electrode surface, can result in a roughened surface that is more durable and less friable. In addition, this approach can retain the existing crystalline morphology of the material of the electrode. Retaining the crystalline morphology can aid in maintaining the structural integrity of the electrodes. For example, retaining the crystalline morphology can prevent structural failure by resisting fatigue of the materials in the electrode.

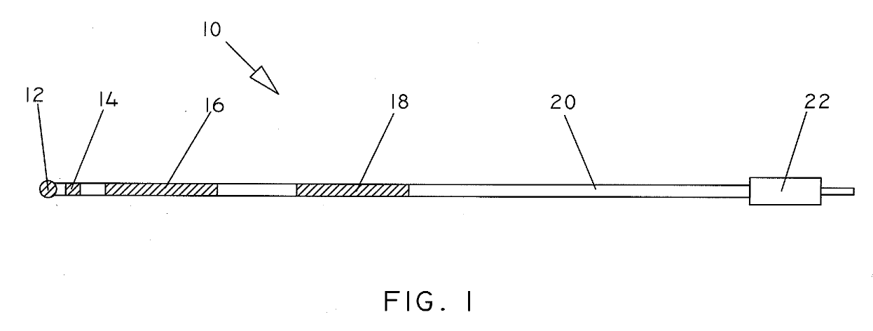

FIG. 1 is a schematic diagram of an exemplary stimulation lead 10 (“lead”) (not to scale) in accordance with an embodiment of the invention. The lead 10 includes a distal pacing/sensing electrode 12, a proximal pacing/sensing electrode 14, a distal shocking coil electrode 16, a proximal shocking coil electrode 18, a lead body 20, and a proximal end connector 22. The proximal end connection 22 can be configured to fit within a port in a header of a CRM device. By way of example, the proximal end can structurally conform to a standard for lead-header interfaces such as the IS-1, IS-4, or DF-1 standards.

The electrodes are configured to interface with cardiac tissue, such as the myocardium, in order to deliver pacing pulses and/or shocks (such as defibrillation shocks) generated by an implantable cardiac rhythm management (CRM) device. The electrodes 12, 14, 16 and 18 can include metals such as noble metals. Specifically, the electrodes 12, 14, 16, and 18 can include platinum. In some cases, the electrodes 12, 14, 16 and 18 can include alloys such as an alloy of platinum and iridium. Some electrodes, such as the shocking coil electrodes 16 and 18, can include a cladding of platinum or a platinum alloy disposed over a substrate. The substrate can include a different conductive material such as titanium. The surfaces of the electrodes 12, 14, 16 and 18 can be modified according to methods herein in order to increase their real surface area.

Referring now to FIG. 2, a schematic diagram is shown of a system 50 for increasing the surface area of an electrode in accordance with an embodiment of the invention. The system 50 includes a function generator 62 and an oscilloscope 64. The function generator can create an oscillating electrical potential and the oscilloscope 64 can be used to monitor the oscillating electrical potentials made by the function generator 62. Many different types of function generators and oscilloscopes can be used and are commercially available. The system 50 also includes a counter electrode 66 and a reference electrode 68 disposed within an electrolyte bath 72. The electrolyte bath 72 can be filled with an electrolyte solution. An electrode to be modified 70 is shown disposed within the electrolyte bath 72. In some embodiments, the counter electrode 66 can include platinum and have a surface area at least twice that of the electrode to be modified (working electrode). The reference electrode 68 can be used to provide a reference point for the amplitude of the oscillating electrical potential delivered by the function generator 62. In some embodiments, a silver/silver chloride (Ag/AgCl) electrode can be used as the reference electrode. In other embodiments, a saturated calomel electrode (SCE) can be used as the reference electrode. Relative to the reference electrode, the high (or peak) and low values for the oscillating electrical potential can be measured in Volts.

While the system for increasing the surface area of an electrode shown in FIG. 2 includes three electrodes (a counter electrode, a reference electrode, and an electrode to be modified or working electrode), it will be appreciated that embodiments of the invention can also include systems including only two electrodes. Specifically, a reference electrode may be omitted in some embodiments. As such, in some embodiments the electrodes of the system include only a counter electrode and a working electrode.

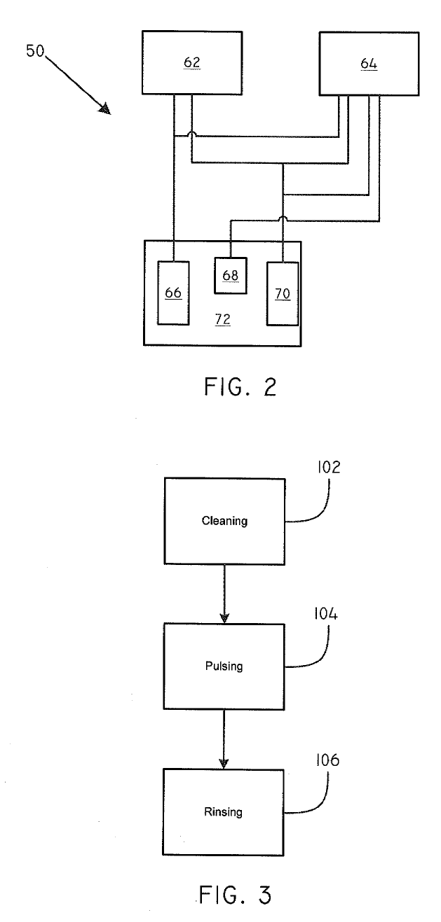

FIG. 3 is a flow chart showing processes that can be performed in some embodiments of the invention. A cleaning step 102 can optionally be performed in order to prepare the surface of an electrode. Then an electrical potential oscillation step 104 can be performed in order to increase the surface area of an electrode. Also, in some embodiments, a rinsing step 106 can be performed.

The cleaning step 102 can include various methods of removing debris and foreign matter from the electrode surface. Cleaning of the electrode surface can include various techniques including the use of solvents, abrasives, mechanical agitation, ultrasonic pulses, electropolishing, etc. In some embodiments, an electropolishing technique is used while the electrode is disposed in an electrolyte solution. Various parameters of the cleaning step 102 such as the cleaning time and conditions will depend on the desired level of cleaning and the condition of the electrode prior to cleaning, amongst other factors. However, in some embodiments, a cleaning step 102 is omitted.

The electrical potential oscillation step 104 can include the application of an oscillating electrical potential at a magnitude and frequency sufficient to remove a portion of the material on the electrode surface in a manner so that the surface area of the electrode is increased. Because of the relationship between electrical potential and electrical current as described by Ohm's Law (V=IR), oscillating the applied electrical potential will cause a varying electrical current to flow. However, the effective impedance of the circuit is variable because of various factors including the electrochemical reactions taking place. As such, the relationship between electrical potential and current will vary with the changing effective impedance. Therefore, while not intending to be bound by theory, it is believed that oscillating the electrical potential (Volts) instead of the current (Amps) can be advantageous because more precise control over the electrochemical reactions can be achieved. This is because the electrochemical reactions taking place are directly determined by the magnitude of the electrical potential and not the current. For example, four common platinum redox reactions are shown below along with their standard state (with reference to a standard hydrogen electrode SHE) reduction half-cell potentials:

Pt(OH)+H⁺+e⁻ [symbol] Pt+H₂O (E^{o}=0.85 V)

PtO+2H⁺+2e⁻ [symbol] Pt+H₂O (E^{o}=0.98 V)

PtO₂+2H⁺+2e⁻ [symbol] PtO+H₂O (E^{o}=1.045 V)

Pt²⁺+2e⁻ [symbol] =Pt (E^{o}=1.188 V)

In some embodiments, the electrode to be modified has a cladding including platinum disposed over a substrate, typically including a metal other than platinum, such as titanium. By way of example, shocking coils are frequently made with a platinum containing cladding disposed over a conductive substrate. The cladding can be of any desired thickness, but in some embodiments is from about 1.0 μm to about 100.0 μm thick. In some embodiments, the cladding is less than or equal to about 10.0 μm thick. It is generally undesirable to remove the cladding from the electrode in an amount so that the underlying substrate is exposed on the surface of the electrode. In addition, in the context of both clad and non-clad electrodes, the electrical properties are dependent in part on the physical size of the electrode and so it is generally undesirable to change the size of the electrode significantly during the process of increasing the surface area. For these reasons, it can be advantageous to limit the amount of material, such as platinum, lost from the electrode into the electrolyte solution.

If the peak value of the oscillating electrical potential is too high, an undesirably large amount of the platinum can be dissolved into the electrolyte solution. In some embodiments, the peak value of the oscillating electrical potential is less than about 5.0 Volts with reference to a saturated calomel electrode (or 5.0 V (SCE)). In some embodiments, the peak value of the oscillating electrical potential is less than about 6.0 V (SCE). In some embodiments, the peak value of the oscillating electrical potential is from about 2.0 V (SCE) to about 4.0 V (SCE).

The low value for the oscillating electrical potential can be greater than about −2.0 V (SCI). In some embodiments, the low value for the oscillating electrical potential can be greater than about −1.0 V (SCE). In some embodiments, the low value for the oscillating electrical potential can be from about −0.5 V (SCE) to about −1.0 V (SCE).

The frequency of the oscillations in the applied electrical potential can affect the process of increasing the surface area. By way of example, an insufficiently low frequency may result in the roughening process taking an undesirably long amount of time. In some embodiments, the frequency is greater than or equal to about 0.1 Hz. In some embodiments, the frequency is less than or equal to about 120 Hz. In some embodiments, the frequency is greater than about 1 Hz. In some embodiments, the frequency is greater than about 2 Hz. If the frequency is too high, material may be removed from the surface of the electrode but the remaining surface will not have the same degree of an increase in surface area. In some embodiments, the frequency is less than about 200 Hz. In some embodiments, the frequency is less than about 120 Hz.

The desired frequency can also depend on other variables of the process such as the pH of the electrolyte solution. For electrolyte solutions that have a pH that is mildly acidic, neutral, or basic, the desired frequency can be somewhat less than for electrolyte solutions that are highly acid. By way of example, if the pH of the electrolyte solution is from about 4 to about 13, then the frequency can be from about 0.1 Hz to about 10 Hz. As another example, if the pH of the electrolyte solution is from about 4 to about 13, then the frequency can be from about 2 Hz to about 5 Hz. However, if the pH of the electrolyte solution is less than 1 than the frequency can be from about 30 Hz to about 120 Hz. In some embodiments, if the electrolyte solution has a pH of less than about 1, the frequency can be about 60 Hz.

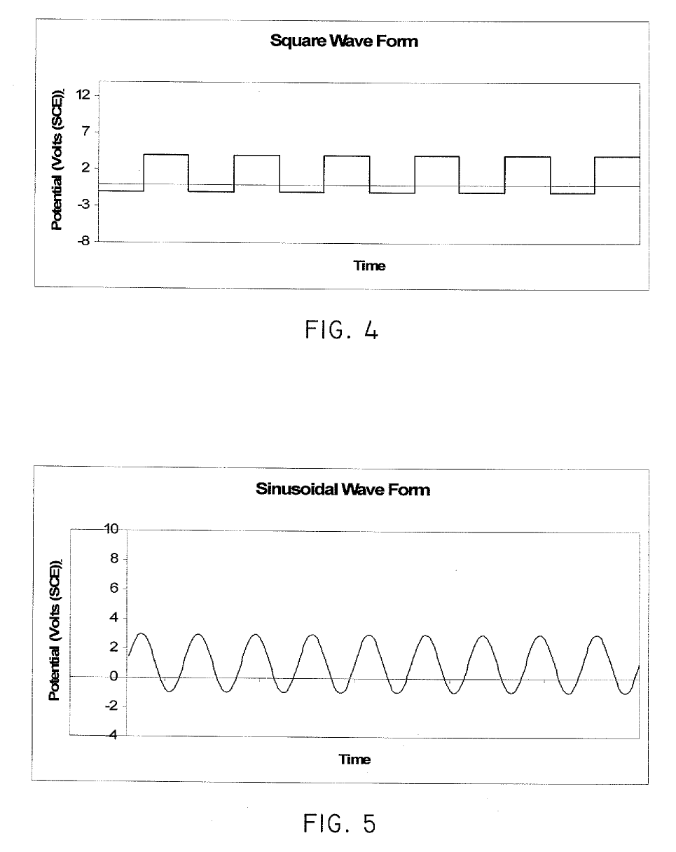

The cyclic oscillations of electrical potential can take on the profile of many different types of waveforms. By way of example, the oscillations can include a square wave form, a pulse wave form, a triangular wave form, a staircase wave forms a saw tooth wave forms a sinusoidal wave form, and the like. In some embodiments, the oscillation of the electrical potential includes an equal amount of time at the high potential and at the low potential. In other embodiments, the time at the high potential is different than the time at the low potential. FIG. 4 shows an exemplary square waveform for the electrical potential in accordance with an embodiment of the invention. FIG. 5 shows an exemplary sinusoidal waveform for the electrical potential in accordance with an embodiment of the invention.

The time associated with increasing the surface area of the electrode will depend on various factors including the other parameters of the pulsing treatment (frequency, amplitude, etc.), the material to be modified, the desired increase in surface area, etc. In some embodiments, a desired level of increased surface area can be achieved in a period of minutes. In an embodiment, the oscillations are conducted for a period of time greater than about five minutes. In an embodiment, the oscillations are conducted for a period of time greater than about ten minutes. In an embodiment, the oscillations are conducted for a period of time greater than about one hour.

If the oscillations of electrical potential are applied over a length of time that is too long, the manufacturing process may be unduly slowed making the process less economically efficient. In an embodiment, the oscillations of electrical potential are applied for a period of time less than one week. In an embodiment, the oscillations of electrical potential are applied for a period of time equal to or less than about thirty-eight hours.

The electrolyte solution can include water and a desired amount of a salt to form ionic species in the solution. By way of example, in some embodiments sodium bicarbonate (NaHCO₃) can be added to water to form an electrolyte solution. However, it will be appreciated that many other compounds can also be used to form ionic species in the electrolyte solution. In some embodiments, the pH of the electrolyte solution can be adjusted to a desirable level by adding an acid or a base to the solution. For example, sulfuric acid (H₂SO₄) can be added to make the electrolyte solution more acidic (lower the pH) or sodium hydroxide (NaOH) can be added to make the electrolyte solution more basic (increase the pH).

While not intending to be bound by theory, the pH of the electrolyte solution can affect the process of increasing the surface area of the electrode. By way, of example, if the electrolyte solution is sufficiently basic, the formation of platinum hydroxide is chemically favored. Consequently, the electrode surface can end up covered by a layer of platinum hydroxide. In this case, to form a surface of elemental platinum, the platinum hydroxide layer must be removed, such as through a reduction process. However, a reduction process is an additional manufacturing step and can result in additional manufacturing time and expense.

However, the formation of a platinum hydroxide layer is chemically less favored if the pH of the electrolyte solution is acidic. In some embodiments the electrolyte solution has a pH of less than about 7.0. In some embodiments, the electrolyte solution has a pH of less than about 6.0. If the pH of electrolyte solution is too acidic then the loss of material from the electrode into the electrolyte solution may be greater than desired. In an embodiment, the pH of the electrolyte solution is greater than about 1.0. In an embodiment, the pH of the electrolyte solution is greater than about 2.0. In some embodiments, the pH of the electrolyte solution is from about 1.0 to about 7.0. In some embodiments, the pH of the electrolyte solution is from about 2.0 to about 6.0. In some embodiments, the pH of the electrolyte solution is from about 4.0 to about 6.0.

Methods as described herein can be used to increase the surface area of an electrode surface. Examples of electrodes that can be modified according to the methods herein can include electrodes of implantable medical devices such as pacing electrodes, shocking electrodes (or coils), stimulation electrodes, and the like. Other types of electrodes and devices with metallic surfaces can also be modified according to the methods herein so as to increase their surface area.

The surface area of an electrode can be measured using various techniques. By way of example, surface area can be measured using optical techniques such as optical profilers and light scattering, electron beam techniques, mechanical techniques, such as atomic force microscope (AFM) surface profiling, and electrochemical techniques, such as cyclic voltammetry.

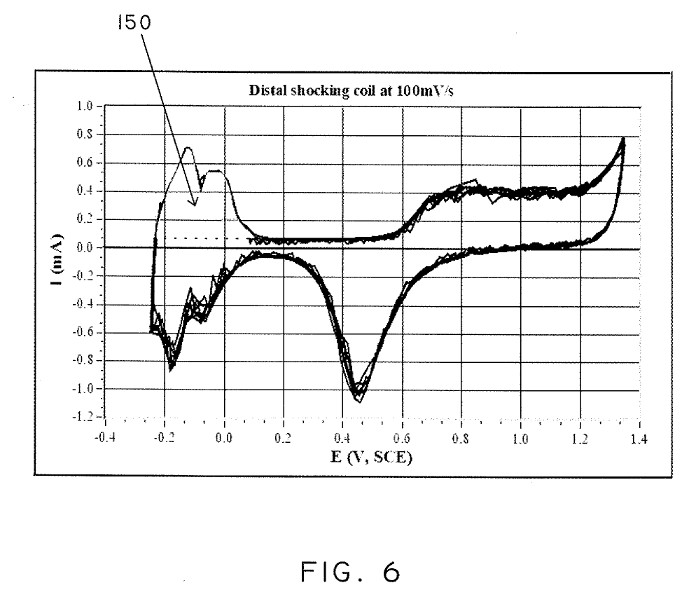

In cyclic voltammetry, the current response over a range of potentials (a potential window) is measured, starting at an initial value and varying the potential in a linear manner up to a pre-defined limiting value. At this potential, referred to as a switching potential, the direction of the potential scan is reversed, and the same potential window is scanned in the opposite direction. The data is then plotted as current (i) vs. potential (E). The current increases as the potential reaches the oxidation/reduction potential of a given redox reaction, but then falls off as the concentration of the analyte is depleted. In the context of elemental platinum, for example, a monolayer of hydrogen can be adsorbed during a forward scan of potential and then desorbed during a reverse scan. The real surface area of the platinum surface can then be assessed by integrating the measured current in the hydrogen potential region from the baseline of the double layer current and dividing that charge (Q_{H}) by the value of 210 μC/cm², a value which is generally known to correspond to the adsorption or desorption of monolayer hydrogen on a polycrystalline platinum surface. FIG. 6 shows an example graph of current versus electrical potential as generated during cyclic voltammetry for a platinum surface of a distal shocking coil in a 0.5 ml/L sulfuric acid solution and a scanning rate of 100 mV/s. The area of region 150 (bounded on the bottom by a dotted line) indicates the measured hydrogen charge (Q_{H}) associated with the hydrogen potential region.

In some embodiments, the real surface area of the electrodes, as measured by cyclic voltammetry, is increased by about two times. In some embodiments, the real surface area of the electrodes, as measured by cyclic voltammetry is increased by about four times. In some embodiments, the real surface area of the electrodes, as measured by cyclic voltammetry, is increased by about ten times. In some embodiments, the real surface area of the electrodes, as measured by cyclic voltammetry, is increased by about twenty times.

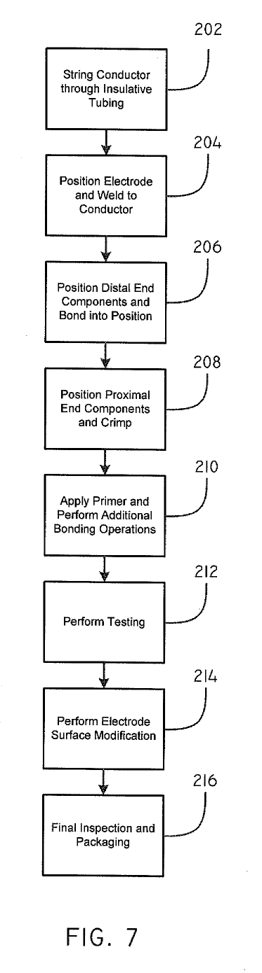

Embodiments of the invention can include a method for manufacturing leads. Many different steps can be performed when manufacturing a lead for implantation within a patient. FIG. 7 is a flowchart of some steps that can be performed during the process of manufacturing a stimulation lead. However, it will be appreciated that many other steps may optionally be performed as well and that some steps can be omitted depending on the nature of the lead to be manufactured.

According to one embodiment, in step 202, a conductor is strung through insulative tubing. In another step 204, electrodes, including pacing, sensing, and/or shocking electrodes, are then positioned and welded to the conductor. Distal end components, such as fixation elements, are then positioned and bonded into position in another step 206. Proximal end components, such as terminal connection components, can be positioned and then crimped to the conductor in another step 208. Primer can be applied to the lead and additional bonding operations can be performed in step 210. Testing of the lead, including functional tests, resistance tests, and/or pressure tests, can be performed in step 212. In step 214, electrode surface modification, such as increasing the surface area of the electrode as described above, can be performed. Then, final inspection and packaging of the lead can be performed in step 216.

In some approaches, the surface of the electrode is modified before the electrode(s) are welded to the conductor. However, while not intending to be bound by theory, such an approach is generally less advantageous because the surface of the electrode is then incidentally exposed to a number of manufacturing steps that may result in physical disruption of the surface and/or exposure to compounds that can function as contaminants when on the surface of an electrode. As such, modifying the surfaces of the electrodes as closely as possible to the final packaging step can offer advantages. In addition, because embodiments of the method of the invention result in the removal of material from the electrode surface, the method can effectively remove potential contaminants from the surface, thereby preparing the electrodes for final packaging.

The present invention may be better understood with reference to the following examples. These examples are intended to be representative of specific embodiments of the invention, and are not intended as limiting the scope of the invention.

### EXAMPLES

### Example 1

### Increasing Surface Area of Electrodes

An electrical potential oscillation system was set-up similarly to as shown in FIG. 2 including a function generator (HP 33120A available from Agilent Technologies, Santa Clara, Calif.) and oscilloscope (TDS 420A available from Tektronix Inc., Beaverton, Oreg.). A saturated calomel electrode (EG&G available from AMETEK Princeton Applied Research, Oak Ridge, Tenn.) was used as the reference electrode. A platinum mesh electrode was used as the counter electrode. The electrolyte solution was formed by adding sodium bicarbonate (Sigma-Aldrich Corp., St. Louis, Mo.) to water at a concentration of 0.1 mol/l. For each test run, the pH of the solution was adjusted to the value shown below in Table 1 using either sodium hydroxide (JT Baker. Phillipsburg, N.J.) or sulfuric acid (JT Baker, Phillipsburg, N.J.). The pH of the electrolyte solution was determined using a pH meter (Cole Parmer pH 100 series, available from Cole-Parmer Instrument Company, Vernon Hills, Ill.) and pH electrode (Cole Parmer 59002-72, available from Cole-Parmer Instrument Company, Vernon Hills, Ill.).

Shocking coil electrodes including a platinum cladding over a titanium substrate were obtained, attached to the electrical potential oscillation system and submersed in the electrolyte solution. An oscillating potential was applied to the shocking coil electrodes according to the conditions described below in Table 1.

TABLE 1

| | | | Pulse Parameters | | | | |
|---|---|---|---|---|---|---|---|
| | Solution | | Potential | | | | |
| | pH | | (V SCE) | | | | |
| Electrode | Initial | Final | High | Low | f (Hz) | Time (h) | Waveform |
| 1 | 4.0 | NA | 4.0 | −1.00 | 0.5 | 16 | Square |
| 2 | 1.5 | 1.5 | 2.2 | −0.70 | 0.5 | 38 | Square |
| 3 | 1.8 | 1.7 | 2.2 | −0.55 | 0.5 | 38 | Square |
| 4 | 8.9 | 9.3 | 2.5 | −0.75 | 0.5 | 18 | Square |
| 5 | 8.9 | 9.3 | 2.2 | −0.60 | 0.5 | 18 | Square |
| 6 | 11.2 | 11.2 | 2.5 | −0.50 | 0.5 | 17.5 | Square |
| 7 | 11.0 | 9.3 | 2.8 | −1.00 | 0.5 | 18 | Square |
| 8 | 4.0 | 9.0 | 2.0 | −0.50 | 0.5 | 17.5 | Square |
| 9 | 3.0 | 2.9 | 2.5 | −0.50 | 0.5 | 17.5 | Square |
| 10 | 3.6 | 5.2 | 2.5 | −0.75 | 1 | 18.5 | Square |
| 11 | 4.5 | 6.6 | 2.5 | −0.50 | 5 | 18.5 | Square |
| 12 | 4.0 | 4.0 | 2.2 | −0.50 | 5 | 14 | Square |
| 13 | 4.0 | 4.0 | 2.2 | −0.50 | 5 | 5.5 | Square |

NA = Not Assessed

After surface modification, each electrode was inspected using techniques including optical microscopy, inductively coupled plasma mass spectrometry (ICP-MS), and cyclic voltammetry. For ICP-MS analysis, a sample of the electrolyte solution was sent to a contract laboratory (Aspen Research Inc.) to detect dissolved Pt, Ta, and Ti.

For cyclic voltammetry (to measure real surface area), the testing setup included a potentiostat (SI 1287 available from Solartron Analytical, Hampshire, UK) and a three-electrode test cell with a volume of 1000 ml. The counter electrode was made of two carbon bars that were placed opposite to each other inside the cell. The reference electrode was a saturated calomel electrode that was connected to the test solution via a junction bridge. The working electrode was the surface modified electrode. The test solution was 0.5 M/l H₂SO₄ solution, prepared with 97% sulfuric acid and de-ionized water. The solution was kept at room temperature. The solution was purged with pure nitrogen before and during the testing. The same solution was used for testing all specimens. After the modified electrode was placed in the test cell, it was scanned in the potential range between −0.25 V and 1.35 V (SCE) at 200 mV/s scan rate for a minimum of 100 cycles or until the cyclic voltammogram (CV) became stable. Afterwards, the electrode was scanned for 10 cycles at 100 mV/s scan rate. The cyclic voltammogram obtained at 100 mV/s rate was then used for real surface area calculation. Specifically, the current in the hydrogen potential region from the baseline of the double layer current was integrated. The real surface area was then calculated by dividing the integrated current (Q_{H}) by the value of 210 μC/cm².

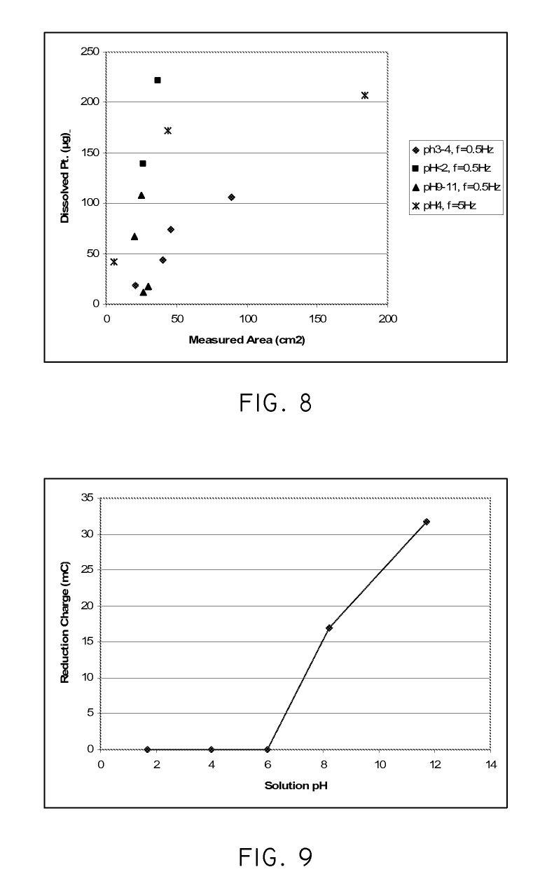

The surface area of the electrodes prior to modification was in the range of 5.0 to 5.5 cm². The data generated by cyclic voltammetry for electrodes after modification are shown below in Table 2. Table 2 also shows amounts of dissolved platinum for each modified electrode as assessed by ICP-MS. FIG. 8 shows a graph of dissolved platinum (as assessed by ICP-MS) versus the measured real surface area, with the data points being grouped into four sets based on solution pH and frequency.

TABLE 2

| | Surface | | |
|---|---|---|---|
| | Area After | | |
| | Modification | Dissolved | |
| Electrode | (cm²) | Pt | Set |
| 1 | 89 | 106 | pH 3–4, f = 0.5 Hz |
| 2 | 37 | 222 | pH <2, f = 0.5 Hz |
| 3 | 26.5 | 139 | pH <2, f = 0.5 Hz |
| 4 | 30 | 17.1 | pH 9–11, f = 0.5 Hz |
| 5 | 24.9 | 108 | pH 9–11, f = 0.5 Hz |
| 6 | 26.5 | 11.4 | pH 9–11, f = 0.5 Hz |
| 7 | 20.3 | 67 | pH 9–11, f = 0.5 Hz |
| 8 | 46 | 74.1 | pH 3–4, f = 0.5 Hz |
| 9 | 21 | 18.8 | pH 3–4, f = 0.5 Hz |
| 10 | 40.5 | 44.2 | pH 3–4, f = 0.5 Hz |
| 11 | 43.7 | 172 | pH 4, f = 5 Hz |
| 12 | 184 | 207 | pH 4, f = 5 Hz |
| 13 | 5.7 | 42.3 | pH 4, f = 5 Hz |

The data generated by cyclic voltammetry show that the real surface area of all electrodes subjected to the oscillating electrical potential was increased significantly.

The ICP-MS data show a positive correlation between the dissolved platinum and the resulting real surface area. Among the four data sets, the pH<2 data set had a steeper increase of dissolved platinum with the real surface area than the other data sets. These data suggest that a low pH solution (pH less than 2) is less efficient than higher pH solutions.

Inspection of the modified electrodes using optical microscopy indicated the formation of a hydroxide film on some of the electrodes. The hydroxide film showed up as a brown, purple, or blue color, depending on the thickness of the film. To quantify the hydroxide film formation, the modified electrodes were placed in sulfuric acid solutions after film formation and the charge required for reducing the oxides were measured. Table 3 shows the oxide reduction charge data. FIG. 9 shows a graph of the charge for oxide film reduction as a function of the electrolyte solution pH used for surface modification.

TABLE 3

| | Oxide |
|---|---|
| | Reduction |
| | Charge |
| pH | (mC) |
| 1.7 | 0 |
| 4 | 0 |
| 6 | 0 |
| 8.2 | 17 |
| 11.7 | 31.7 |

The data show that at neutral and alkaline pH solutions, a hydroxide film was formed on the surface of the electrode. However, a hydroxide film did not form in acidic pH electrolyte solutions. Specifically, the data show that a hydroxide species was not formed on the surface of the electrode at a solution pH of 6 and below.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”. “manufactured and arranged”, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive. The scope of the present subject matter should be determined with reference to the appended claims, along with the full scope of equivalents to which such claims are entitled.

What is claimed is:

1. A method for increasing the surface area of an electrode of an implantable medical device the method comprising:
immersing the electrode in an electrolyte solution, the electrode having a surface comprising platinum; and
oxidatively removing material from the surface of the electrode.

2. The method of claim 1, the electrode comprising an alloy of platinum and iridium.

3. The method of claim 1, wherein oxidatively removing material from the surface of the electrode comprises applying an oscillating electrical potential comprising a peak of equal to or less than about 4.0 V (SCE) to the electrode at a frequency of about 0.1 Hz to about 120 Hz.

4. The method of claim 1, the electrolyte solution having a pH of less than about 6.0.

5. The method of claim 1, the electrolyte solution having a pH of greater than about 2.0.

6. The method of claim 1, the oscillating electrical potential comprising a square waveform.

7. The method of claim 1, the oscillating electrical potential comprising a peak of about 2.0 V (SCE) to about 4.0 V (SCE).

8. The method of claim 1, the oscillating electrical potential comprising a minimum of about −0.5 V (SCE) to about −1.0 V (SCE).

9. The method of claim 1, the oscillating electrical potential having a frequency of about 0.1 Hz to about 10 Hz.

10. The method of claim 1, the oscillating electrical potential having a frequency of about 2 Hz to about 5 Hz.

11. The method of claim 1, the electrode comprising a platinum cladding disposed over a substrate.

12. The method of claim 1, wherein the real surface area of the electrode is increased by at least about two times as assessed by cyclic voltammetry.

13. The method of claim 1, wherein the real surface area of the electrode is increased by at least about twenty times as assessed by cyclic voltammetry.

14. A method for increasing the surface area of an electrode of an implantable medical device, the method comprising:
immersing the electrode in an electrolyte solution, the electrode comprising platinum; and
applying an oscillating electrical potential with a peak of equal to or less than about 4.0 Volts (SCE) to the electrode at a frequency of about 0.1 Hz to about 120 Hz to increase the surface area of the electrode.

15. The method of claim 14, the electrolyte solution having a pH of less than about 7.0.

16. The method of claim 14, the electrolyte solution having a pH of less than about 6.0.

17. The method of claim 14, the electrolyte solution having a pH of greater than about 2.0.

18. The method of claim 14, the oscillating electrical potential comprising a square waveform.

19. The method of claim 14, the oscillating electrical potential comprising a peak of about 2.0 V (SCE) to about 4.0 V (SCE).

20. The method of claim 14, the oscillating electrical potential comprising a minimum of about −0.5 V (SCE) to about −1.0 V (SCE).

21. The method of claim 14, the oscillating electrical potential having a frequency of about 0.1 Hz to about 10 Hz.

22. The method of claim 14, the oscillating electrical potential having a frequency of about 2 Hz to about 5 Hz.

23. The method of claim 14, the electrode comprising a platinum cladding disposed over a substrate.

24. The method of claim 23, the platinum cladding having a thickness of greater than about 10 μm.

25. The method of claim 14, wherein formation of the surface features on the electrode results in increasing the real surface area of the electrode by at least about twenty times as assessed by cyclic voltammetry.

26. The method of claim 14, the oscillating voltage applied for a period of time of between about 0.5 hours and about 38 hours.

27. A method for manufacturing an implantable stimulation lead comprising:
welding an electrode to a conductor; and
increasing the surface area of the electrode by oxidatively removing a portion of the electrode surface.
